(19) United States
(12) Patent Application Publication
(10) Pub. No.: US 2006/0032942 A1
(43) Pub. Date: Feb. 16, 2006

(54) Quick disconnect valve for irrigation systems

(76) Inventor: Ali Marandi, Irvine, CA (US)

Correspondence Address: Boniard I. Brown, 1500 West Covina Parkway, #113, West Covina, CA, 91790-2793, US

(21) Appl. No.: 10/918,589

(22) Filed: Aug. 16, 2004

(51) Int. Cl. B05B 15/06; B05B 1/00; A01G 25/06

(52) U.S. Cl. 239/200; 239/600; 239/201

(57) ABSTRACT

A quick disconnect valve is disposed between a water source and a valve-in-head sprinkler. Separating movement of the sprinkler from a valve housing moves a valve to sealing engagement with a valve seat, and spring means urge the valve to engage the valve seat upon separating movement of the sprinkler from the valve housing.

### BACKGROUND AND SUMMARY

Large irrigated areas, including golf courses, generally utilize sprinkler systems wherein a plurality of solenoid-controlled valves are each controlled by a central computer.

The replacement of a defective valve-in-head sprinkler has heretofore involved the closing down of at least a substantial line or plurality of sprinklers and/or the draining-of substantial water over an area where a defective valve-in-head sprinkler is being replaced.

The present invention provides a quick disconnect valve disposed between a valve-in-head sprinkler and a water source. The sprinkler is removable and replaceable without shutting down or closing any water input line or other sprinklers in the line, and without leakage or loss of water.

Separating movement of the valve-in-head sprinkler relative to the valve housing moves the valve means into sealing engagement with a valve seat, spring means of the valve assembly urging the valve means to engage the valve seat upon separating movement of the sprinkler housing relative to the valve housing.

A valve assembly has extending portions to engage shoulders in a sprinkler housing to retain the valve assembly from movement outwardly of the valve housing during operation of the sprinkler and valve housing.

### BRIEF DESCRIPTION OF THE DRAWINGS

FIG. 1 is a schematic showing of a large landscape irrigation arrangement, typically a golf course;

FIG. 2 is an elevational view of a valve-in-head sprinkler, valve housing and swing joint assembly for water supply;

FIGS. 3A and 3B are sectional views of a valve housing and valve assembly in different positions of operation;

FIG. 4 is a sectional view taken at line 4-4 in FIG. 3A; and

FIG. 5 is a sectional view of a sprinkler housing, valve housing, and valve and seat members.

### DESCRIPTION OF A PREFERRED EMBODIMENT

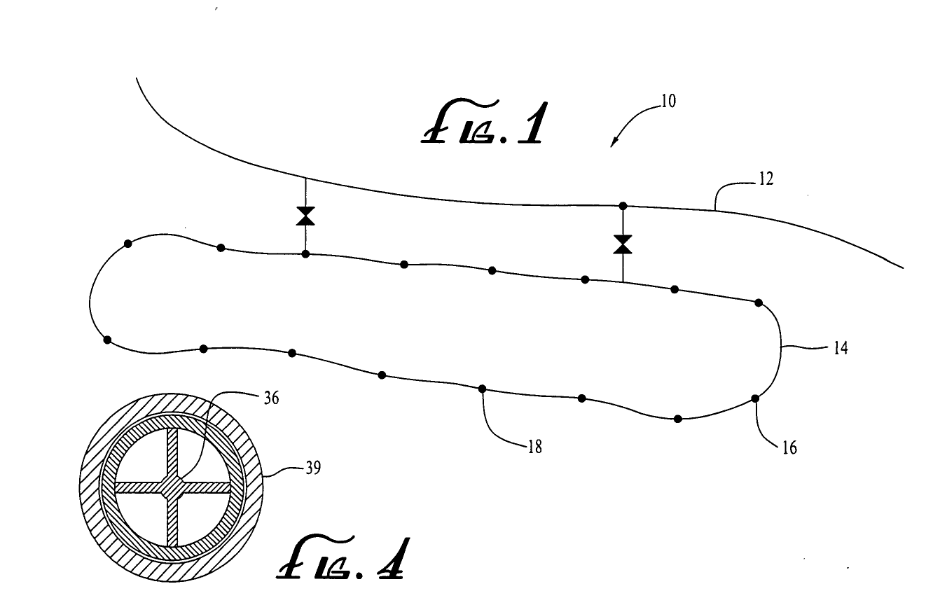

Referring to the drawings, FIG. 1 is a schematic illustration of a large landscape irrigation system, comprising a golf course or other major installation 10, which comprises a main line 12 and a lateral loop portion 14, with which the present invention may be utilized. The lateral loop portion 14 has a plurality of sprinklers including sprinklers 11 and 18, which typically are disposed at different elevations. The system has valves connecting the system with the water line 12.

Heretofore in the prior art the removal of one of the sprinklers, as for replacement, causes a substantial water loss via a drainage system before valve repair or replacement can commence or be completed.

The present invention enables the replacement of a faulty leaking in-head sprinkler while under pressure without necessity of isolating or shutting off of a water line connected with the sprinkler.

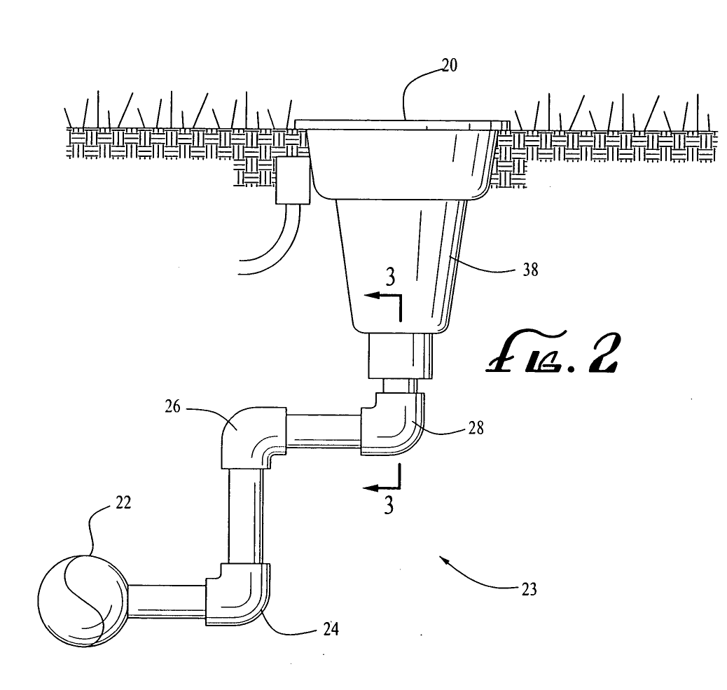

Referring to FIG. 2, a typical valve-in-head sprinkler 20 is attached to a lateral line 22 by a swing joint riser assembly 23 comprising three elbows 24, 26, 28, with interlinking nipples, as shown, which allow a sprinkler to be disposed in a desired position and orientation in three-dimensional space.

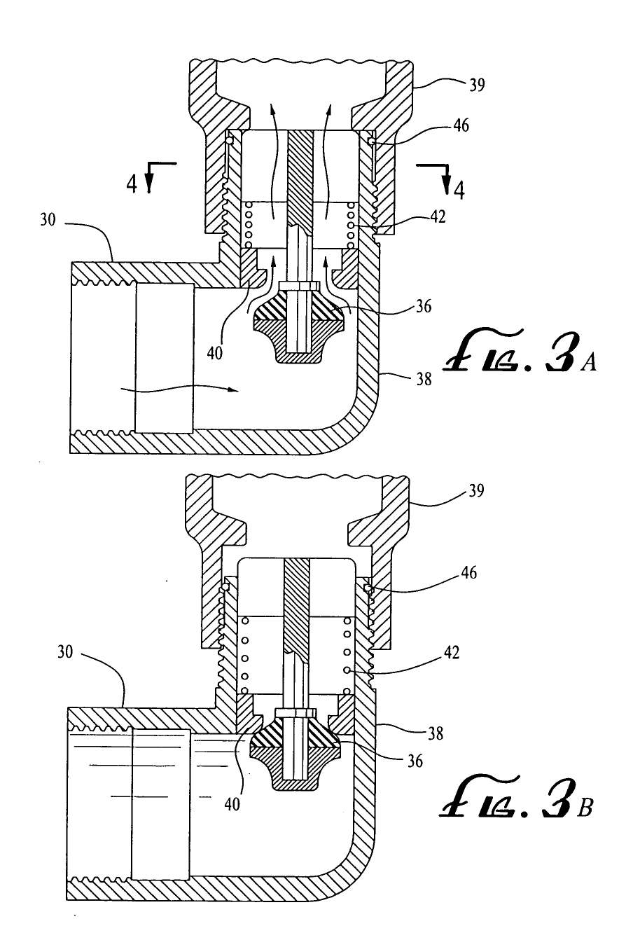

The quick disconnect valve assembly of the invention is disposed between a valve-in-head sprinkler and a water source. The sprinkler is threadedly mounted on the valve housing, as indicated in FIGS. 5, 3A, and 3B.

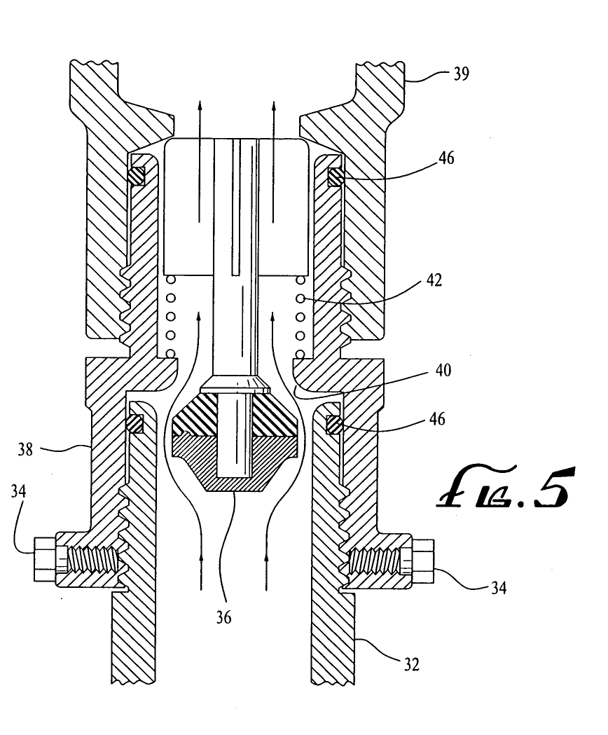

Referring to FIGS. 3A, 3B, 4 and 5, the apparatus of the invention may preferably be disposed in a bent inlet conduit 30, and secured to an inlet conduit 32 by locking screws 34 (FIG. 5).

A valve member 36 is movably mounted in valve housing 39 which is threadedly connected with the housing of sprinkler 38, as shown. The valve member 36 is axially movable relative to a valve seat 40.

A resilient seal 46 is disposed between the valve housing 39 and the inlet conduit 30.

A spring 42 acts on radially extending spoke members on the valve assembly (FIGS. 3A and 5).

Disengaging the sprinkler 38 from the valve housing by unthreading rotation of the sprinkler, moves the valve member 36 into sealing engagement with the valve seat 40, spring 32 urging the valve to engage the valve seat.

FIG. 5 shows a modified form of the assembly of FIGS. 3A and 3B.

One or more threaded locking screws may be utilized to secure the valve housing to an inlet water pipe, as indicated in FIG. 5.

Resilient spring means 42 on the valve housing serve to resiliently urge the valve means toward the valve seat.

The inventor claims:

1. A quick disconnect valve assembly disposed between a valve-in-head sprinkler and a water source, comprising:
a sprinkler mounted on a valve housing,
valve means and a valve seat disposed in the valve housing,
separating movement of the sprinkler relative to the valve housing moving the valve means into sealing engagement with said valve seat, and
means to supply water to said sprinkler via said valve,
whereby a sprinkler is removed and replaced without isolation or closing of any water line connected with the sprinkler.

2. A valve assembly according to claim 1, and further comprising means on the valve housing to resiliently urge the valve means toward the valve seat.

3. A valve assembly according to claim 1, and further comprising spring means to urge the valve means to engage the valve seat.

4. A valve assembly according to claim 1, and further comprising at least one threaded locking member to secure the valve housing to a liquid conduit on which the valve housing is mounted.

5. A valve assembly according to claim 1, wherein the valve housing is connected with a swing joint assembly.

6. A quick disconnect valve assembly disposed between a valve-in-head sprinkler and a water source, comprising:
a valve housing,
a sprinkler threadedly mounted on the valve housing,
valve means and a valve seat disposed in the valve housing to prevent flow through the valve housing when closed,
separating unthreading movement of the sprinkler relative to the valve housing moving the valve means into sealing engagement with said valve seat, and
means to supply water to said sprinkler via said valve,
whereby a sprinkler is removable and replacable without isolation or closing of any water line connected with the sprinkler.

7. A valve assembly according to claim 6, and further comprising at least one threaded locking member to secure the valve housing to a liquid conduit on which the valve housing is mounted.

8. A valve assembly according to claim 6, wherein the valve housing is connected with a swing joint assembly.

9. A valve assembly according to claim 6, and further comprising means on the valve housing to resiliently urge the valve means toward the valve seat.

10. A valve assembly according to claim 6, and further comprising spring means to urge the valve means to engage the valve seat.

11. A quick disconnect valve assembly disposed between a valve-in-head sprinkler and a water source, comprising:
a valve housing,
a sprinkler threadedly mounted on the valve housing,
valve means disposed in the valve housing to prevent flow through the valve housing when closed,
separating movement of the sprinkler relative to the valve housing moving the valve means into sealing engagement with said valve seat,
resilient means disposed to urge the valve means to engage the valve seat upon separating movement of the sprinkler housing relative to the valve housing, and
means to supply water to said sprinkler via said valve,
whereby a sprinkler is removable and replaceable without isolation or closing of any water line connected with the sprinkler.

12. A valve assembly according to claim 11, and further comprising spring means to urge the valve means to engage the valve seat.

13. A valve assembly according to claim 11, and further comprising at least one threaded locking member to secure the valve housing to a liquid conduit on which the valve housing is mounted.

14. A valve assembly according to claim 11, wherein the valve housing is connected with a swing joint assembly.

15. A valve assembly according to claim 11, and further comprising means on the valve housing to resiliently urge the valve means toward the valve seat.
